(19) United States
(12) Patent Application Publication
(10) Pub. No.: US 2020/0372400 A1
(43) Pub. Date: Nov. 26, 2020

(54) TREE ALTERNATING OPTIMIZATION FOR LEARNING CLASSIFICATION TREES

(71) Applicant: The Regents of the University of California, Oakland, CA (US)

(72) Inventor: Miguel Á. CARREIRA-PERPIÑÁN, Merced, CA (US)

(21) Appl. No.: 16/419,917

(22) Filed: May 22, 2019

(51) Int. Cl. G06N 20/00; G06K 9/62; G06F 16/901

(52) U.S. Cl. CPC G06N 20/00; G06F 16/9027; G06K 9/6282

(57) ABSTRACT

Computer-implemented methods for learning decision trees to optimize classification accuracy, comprising inputting an initial decision tree and an initial data training set and, for nodes not descendants of each other, if the node is a leaf, assigning a label based on a majority label of training points that reach the leaf, and if the node is a decision node, updating the parameters of the node's decision function based on solution of a reduced problem, iterating over the all nodes of the tree until parameters change less than a set threshold, or a number of iterations reaches a set limit, pruning the resulting tree to remove dead branches and pure subtrees, and using the resulting tree to make predictions from target data. In some embodiments, the TAO algorithm employs a sparsity penalty to learn sparse oblique trees where each decision function is a hyperplane involving only a small subset of features.

### GOVERNMENT LICENSE RIGHTS

This invention was made with government support under Grant No.: U.S. Pat. No. 1,423,515 awarded by the National Science Foundation. The government has certain rights in the invention.

### FIELD OF THE INVENTION

The invention generally relates to the field of machine learning. More specifically, certain embodiments of the present invention relate to learning better classification trees by application of novel methods using a tree alternating optimization (TAO) algorithm.

### DISCUSSION OF THE BACKGROUND

Decision trees are among the most widely used statistical models in practice. They are routinely at the top of the list in annual polls of best machine learning algorithms. Many statistical or mathematical packages such as SAS® or MATLAB® implement them. Decision trees are able to model nonlinear data and have several unique, significant advantages over other models of machine learning.

A decision tree is an aptly named model, as it operates in a manner that may be partially illustrated using common knowledge of biological trees. The prediction made by a decision tree is obtained by following a path from a root to a leaf consisting of a sequence of decisions, and making a prediction (for a class) in that leaf. Just as a biological tree routes a water molecule from root to a leaf, so too does the decision tree route a decision along a path that may be analogized to roots, trunk, branches, stems, and ultimately the leaf.

In a decision tree, each movement along the tree involves a question at a particular decision node i of the type: is “xⱼ>bᵢ” for axis-aligned, or univariate, trees (is feature j greater than threshold bᵢ); or for oblique, or multivariate, trees: is “wᵢ^{T}x>bᵢ” (is a linear combination of all the features using weights in vector wᵢ greater than threshold bᵢ). Consequently, inference based on a decision tree is very fast, particularly for axis-aligned trees, as there may not even be a need to use all input features to make a prediction. The path can be understood as a sequence of IF-THEN rules, which is intuitive to humans, and one can equivalently turn the tree into a database of rules. These characteristics often make decision trees preferable over models that are more accurate (e.g., neural nets) in some applications. Areas where decision trees are often preferable include decision-making in medical diagnosis, financial applications or legal analysis.

However, decision trees pose one crucial problem that is currently unsolved, and addressed by inadequate partial solutions: learning or creating a tree from data presents a very difficult optimization problem, involving a search over a complex and large set of tree structures, and over the parameters at each node.

To learn a tree (also called “tree induction”), the algorithms that have stood the test of time to date, in spite of their clear sub-optimality, are greedy growing and pruning (or variations thereof), such as Classification and Regression Trees (“CART”) or C4.5. “CART-type algorithms” will be used to refer to these conventional algorithms. In CART-type algorithms, a tree is grown by recursively splitting each node into two children, using an impurity measure. The growing process may be stopped and the tree returned when the impurity of each leaf falls below a set threshold. Somewhat better trees may be produced by growing a large tree and pruning it back one node at a time. At each growing step, the parameters at the node are learned by minimizing an impurity measure including, without limitation, the Gini index, cross-entropy, or misclassification error. The goal is to find a bipartition where each class is as pure (single-class) as possible.

Minimizing the impurity over the parameters at the node depends on the node type. For axis-aligned trees, the exact solution can be found by enumeration over all (feature, threshold) combinations. For oblique trees, minimizing the impurity is much harder because the impurity is a non-differentiable function of the real-valued weights. Various approximate approaches exist (such as coordinate descent over the weights at the node), but they tend to lead to poor local optima.

The optimization over the node parameters assumes the rest of the tree (structure and parameters) is fixed. The greedy nature of CART-type algorithms means that once a node is optimized, it is fixed forever. Hence, sub-optimally determined nodes accumulate as the tree is grown. Finally, it is in each leaf where an actual predictive model is fit to the training instances that reach the leaf. For classification, this predictive model is often the majority label of the training instances in the leaf.

The overwhelming majority of trees currently used in practice are axis-aligned, not oblique. This is because, due to the suboptimal tree learning, often an axis-aligned tree will outperform an oblique tree in test error. Even if the oblique tree has a lower test error, the improvement is usually small and does not compensate for the fact that the oblique tree is slower at inference and less interpretable (since each node involves all features). Heavy reliance on axis-aligned trees is unfortunate because an axis-aligned tree imposes an arbitrary region geometry that is unsuitable for many classification problems and results in larger trees than would be needed otherwise.

Other approaches to learn decision trees have been proposed over the years, but none of them have replaced CART-type algorithms in practice.

Much of the prior research has focused on optimizing the parameters of a tree given an initial tree (possibly obtained with greedy growing and pruning) whose structure remains fixed. Some research casts the problem of optimizing a fixed tree as a linear programming problem, in which a global optimum could be found. However, the linear program is so large that the procedure is only practical for very small trees. Also, it applies only to binary classification problems (where the output is one of two class labels), and therefore, is limited in its application. Other methods optimize an upper bound over the tree loss using stochastic gradient descent, but this is not guaranteed to decrease the classification error.

Yet other researchers formulate the optimization over tree structures (limited to a given tree depth) and node parameters as a mixed-integer optimization (MIO) by introducing auxiliary binary variables that encode the tree structure. Then, state-of-the-art MIO solvers (based on branch-and-bound) may be applied that are guaranteed to find the globally optimum tree (unlike the classical, greedy approach). However, this has a worst-case exponential cost and is not practical unless the tree is very small (e.g., a depth 2-4).

Finally, soft decision trees assign a probability to every root-leaf path of a fixed tree structure, such as the hierarchical mixture of experts. The parameters can be learned by maximum likelihood with an expectation-maximization (EM) or gradient-based algorithm. However, this loses the fast inference and interpretability advantages of regular decision trees, since now an instance must follow each root-leaf path.

Consequently, because all of these approaches are suboptimal, there is a need for methods to learn better classification trees than these conventional algorithms and methods, in order to improve classification accuracy, interpretability, model size, speed of learning the tree and of using it to classify an instance (target data), as well as other factors more fully described below. It should be understood that the approaches described in this section are for background purposes only. Therefore, no admission is made, nor should it be assumed, that any of the approaches described in this section qualify as prior art merely by virtue of their inclusion in this section.

### SUMMARY OF THE INVENTION

The present invention advantageously provides, among other things, better methods for learning decision trees that improve classification accuracy, interpretability, model size, speed of learning the tree, and speed of classifying an instance. In some embodiments of the invention, methods assume a tree structure given by an initial decision tree (grown by CART or another conventional method, or using random parameter values), and through use of a tree alternating optimization (TAO) algorithm, returns a tree that is smaller or equal in size than the initial tree and reduces the classification error of the tree.

Additionally, in some embodiments, TAO produces a new type of tree, namely, a sparse oblique tree, where each decision function is a hyperplane involving only a small subset of features, and whose structure is a pruned version of the original tree. These methods utilizing the TAO algorithm directly optimize the quantity of interest (i.e., the classification error). The invention may provide other optimizations or benefits as well.

It is therefore an object of the invention to take an initial decision tree structure having initial models at the nodes and return a tree that is smaller or equal in size than that of the initial tree.

It is also an object of the invention to take an initial decision tree and return a tree that produces a lower or equal classification error than the initial tree in the training set.

It is further an object of the invention to provide methods for learning decision trees scalable to large trees.

It is further an object of the invention to provide methods for learning decision trees scalable to large datasets.

It is further an object of the invention that the resulting decision tree be easily interpretable.

It is further an object of the invention to provide methods for learning decision trees that improve classification accuracy.

It is further an object of the invention to provide methods for learning decision trees that increase the speed of learning the tree.

It is further an object of the invention to provide methods for learning decision trees that increase the speed of classifying an input instance using the resulting tree.

It is to be understood that both the foregoing general description and the following detailed description are exemplary, but not restrictive, of the invention. A more complete understanding of the methods disclosed herein will be afforded to those skilled in the art.

### BRIEF DESCRIPTION OF THE DRAWINGS

FIG. 1 shows a binary decision tree T(⋅; Θ) of depth 3, an input x, output y=T(x; Θ), a decision function ƒᵢ(x; θᵢ) at each decision node, and a label θᵢ at each leaf.

FIG. 2 shows the final tree structure after post-processing the tree learned by an embodiment of TAO for the binary decision tree of FIG. 1.

FIG. 3 is a schematic representation of the optimization over node 2 in the tree of FIG. 1.

FIG. 4 is a flow diagram of a method for learning a classification tree according to an embodiment of the invention.

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications, and equivalents that may be included within the spirit and scope of the invention. Furthermore, in the following detailed description of the present invention, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. These conventions are intended to make this document more easily understood by those practicing or improving on the inventions, and it should be appreciated that the level of detail provided should not be interpreted as an indication as to whether such instances, methods, procedures or components are known in the art, novel, or obvious.

The following methods of learning and growing decision trees may be used for medical diagnosis, legal analysis, image recognition (whether moving, still, or in the non-visible spectrum, such as x-rays), loan risk analysis, other financial/risk analysis, etc. The methods may further be utilized, in whole or in part, to improve non-player characters in games; to improve control logic for remotely operated devices; to improve control logic for autonomous or semi-autonomous devices; to improve control logic for self-driving cars, self-piloting aircraft, and other autonomous or semi-autonomous transportation modalities; to improve search results; to improve routing of internet or other network traffic; to improve performance of implanted and non-implanted medical devices; to improve identification of music; to improve object identification in moving and still images; to improve computerized analysis of microexpressions; to improve computerized analysis of behavior, such as analysis of suspect behavior at an airport checkpoint; to improve the ability to obtain an accurate estimate of elements that are too computationally resource-intensive to solve with certainty; to compute hash codes or fingerprints of documents, images, audio or other data items; to understand, interpret, audit or manipulate models (such as neural networks); for automated analysis of patent applications, issued patents, and prior art; for running simulations; and for various other tasks that benefit from the invention.

The invention is described in terms of classification trees having a binary split at each node, where the bipartition in each node is either an axis-aligned hyperplane (axis-aligned or univariate trees) or an arbitrary hyperplane (oblique or multivariate trees).

In an embodiment, TAO works by repeatedly training a simple classifier (binary linear classifier at the decision nodes, K-class majority classifier at the leaves) while, in some embodiments, monotonically decreasing the objective function. In order to optimize the classification error over the entire tree, TAO fundamentally relies on alternating optimization, which is most effective when two circumstances apply: (1) some separability into blocks exists in the problem; and (2) the step over each block is easy and ideally exact.

TAO is different from CART-type algorithms, which grow a tree greedily, optimizing the impurity of a single node as the node is split, and then fixing it forever. Instead, TAO iteratively optimizes the classification error of the entire tree; each TAO iteration updates the entire set of nodes in the tree (i.e., all the weights and thresholds of all the hyperplanes in the decision nodes, and all the labels in the leaves). Minimizing the classification error of the entire tree on the training data, rather than the impurity in each node, is critical to learning a good tree. Minimizing impurity at each node is only indirectly related to the classification accuracy of the tree, and does not produce the same efficient and accurate classification as the present invention.

In a preferred embodiment, TAO takes as an initial tree a complete binary tree of a depth selected by a user to be large enough for the user's problem to be solved and having random parameter values in the models at the nodes. TAO can be applied to any tree, however, such as a tree constructed by a CART-type algorithm.

TAO optimizes the following objective function jointly over the parameters θ={θᵢ} of all nodes i of the tree:

$$E ( Θ ) = {\sum }_{n = 1}^{N} L ( {\overline{y}}_{n} , T ( {x}_{n} ; Θ ) ) + λ {\sum }_{decision nodes i} {‖ {w}_{i} ‖}_{1} \qquad Equation ( 1 )$$

The first term on the right of the equal sign is the classification error on the training set {(xₙ, yₙ)}ₙ₌₁^{N}⊂R^{D}×{1, . . . , K} of D-dimensional real-valued instances and their labels (in K classes), where L (⋅, ⋅) is the 0/1 loss (i.e., L (y, y′)=0 if y=y′ and L (y, y′)=1 otherwise), and T (x; Θ): R^{D}→{1, . . . , K} is the predictive function of the tree. This function is obtained by propagating x along a path from the root down to a leaf, computing a binary decision ƒᵢ(x; θᵢ): R^{D}→{left, right} at each internal node i along the path, and outputting the leaf's label. Hence, the parameters θᵢ at a node i are:
If i is a leaf, θᵢ={yᵢ}={1, . . . , K} contains the label at that leaf;
If i is a decision node, θᵢ={wᵢ, bᵢ} where wᵢϵR^{D} is the weight vector and bᵢϵR the threshold for the decision hyperplane “wᵢ^{T}−bᵢ≥0”. For axis-aligned trees, the weight vector wᵢ has all elements equal to zero except for one element which is equal to one. For oblique trees, wᵢ is unrestricted.

The second term on the right is an L1 penalty (sum of the absolute values of the weights of each weight vector wᵢ), controlled by a user-set hyperparameter λ≥0. Large values of λ have the effect of making exactly zero some of the weights.

The TAO algorithm to minimize Equation (1) is based on two theorems:

### Theorem 1: Separability Condition.

Consider a set of nodes that are not descendants of each other. Then, as a function of these nodes (keeping all other nodes fixed), E(Θ) in Equation (1) is a separable function. This means that optimizing E over the set of nodes not descendants of each other can be equivalently done by optimizing E separately over each node's θᵢ.

### Theorem 2: Reduced Problem.

The problem of optimizing E(Θ) over one node's θᵢ is as follows:
If i is a leaf, then the optimal solution for θᵢ ϵ{1, . . . , K} is the majority class over the “reduced set” of instances (the training instances that reach the leaf).
If i is a decision node, the optimization problem is equivalent to a binary classification problem using the 0/1 loss and a penalty λ∥wᵢ∥₁, with a linear classifier with parameters θᵢ, over the set of “care” instances (defined below) of that decision node. For axis-aligned trees, this can be solved exactly by enumeration. For oblique trees, it can be solved approximately by a suitable surrogate loss (such as the logistic or hinge loss). Additional detail is provided below.

The separability condition allows optimization to occur separately (and, in some embodiments, in parallel) over the parameters of any set of nodes that are not descendants of each other, fixing the parameters of the remaining nodes. This has at least two advantages. First, a deeper decrease of the loss is expected, because optimization occurs over a large set of parameters exactly. This is because optimizing over each node can often be done exactly, and the nodes separate. Second, the computation is fast and less computationally expensive: the joint problem over the set becomes a collection of smaller independent problems over the nodes that can, in some embodiments, be solved in parallel. There are many possible choices of such node sets, and it is typically preferred to make those sets as big as possible, so that large, fast moves are made in the search space. In some aspects, a node set is “all nodes at the same depth” (distance from the root), although other node sets are possible, so long as none of the nodes in the set are descendants of each other.

The reduced problem theorem shows how to solve the problem of optimizing over a single node's parameters (keeping fixed the parameters of all other nodes). The apparently complex problem of optimizing E(Θ) over a single node simplifies enormously and can be solved using known, efficient techniques in machine learning, as mentioned below. The solution is exact for leaves and for axis-aligned decision nodes, and approximate (but typically very accurate) for oblique decision nodes.

In some embodiments, one iteration of TAO proceeds from the bottom of the tree (leaves) to the top (root), and repeated iterations also proceed bottom to top, bottom to top, etc. (reverse breadth-first search (BFS) order). In other embodiments, an iteration may proceed in other orders, such as, but not limited to: top to bottom, top to bottom, etc.; or alternating top to bottom, bottom to top, top to bottom, etc., and similar variations.

When optimizing over a set of non-descendant nodes (such as all the nodes at a given depth level), the optimization preferably occurs in parallel over all the nodes in the set. This, and the fact that solving for each node only requires its reduced set of instances, greatly accelerates the training time of the algorithm.

### Post-Processing of the Tree

As TAO iterates, the root-leaf path followed by each training instance changes and so does the set of instances that reach a particular node. This can cause dead branches and pure subtrees, which may be removed. In a preferred embodiment, this is done as a post-processing step, after the last iteration of TAO. This makes it possible to reuse nodes that, having become empty or pure at some iteration, become nonempty or impure at a later iteration. During each TAO iteration, only non-empty, impure nodes are processed, so dead branches and pure subtrees are ignored, which accelerates the algorithm. Alternatively, such nodes may be pruned as soon as they become empty or pure, but this has the risk that nodes pruned cannot be unpruned in subsequent iterations. Either way, the result is a tree of smaller or equal size than that of the initial tree but with the same or greater accuracy in the training set.

The pruning is done as follows:
Dead branches arise if, after optimizing over a node, some of its subtrees (a child or other descendants) become empty because they receive no training instances from their parent (which sends all its instances to the other child). The subtree of a node with one empty child can be replaced with the non-empty child's subtree.
Pure subtrees arise if, after optimizing over a node, some of its subtrees become pure (i.e., all their instances have the same label). A pure subtree can be replaced with a leaf.

Consequently, methods utilizing the TAO algorithm modify the tree structure, by reducing the size of the tree. This pruning is very significant with sparse oblique trees (described below). A smaller tree that decreases the training loss is achieved, and a smaller tree is faster, takes less space, has fewer parameters, is more easily interpretable, and generalizes better.

### Optimizing the Objective Function at a Single Node: The Reduced Problem

We now describe how to solve the reduced problem in theorem 2, that is, how to update the parameters θᵢ at a given node. We define the “reduced set” of a node as the training instances that currently reach that node.

For a leaf, this is simple: the problem is solved exactly by majority vote, namely, setting the leaf label θᵢ to the most frequent label in the leaf's reduced set.

For a decision node, the following procedure is performed: let xₙ be an instance in the reduced set and yₙϵ{1, . . . , K} be its ground-truth label (in the training set). This instance is assigned a binary pseudo label y̅ₙϵ{left, right} as follows:
If sending xₙ down the node's left child produces the label yₙ and sending xₙ down the node's right child produces a label different from yₙ then set y̅ₙ=left.
If sending xₙ down the node's right child produces the label yₙ and sending xₙ down the node's left child produces a label different from yₙ, then set y̅ₙ=right.
xₙ is removed from the reduced set in any other case, that is, whether both children predict yₙ, or each child predicts a label different from yₙ.

This process is repeated for each instance in the reduced set. The resulting set of instances, is the “care set” (instances that were not removed from the reduced set because their choice of child (left or right) affects the 0/1 classification loss). Each instance in the care set has a binary pseudo label. The instances removed from the reduced set (“don't care set”) do not affect the 0/1 classification loss no matter which child they choose.

Finally, the reduced problem for a decision node i is to minimize:

$${E}_{i} ( {θ}_{i} ) = {\sum }_{n ∈ care set} L ( {\overline{y}}_{n} , {f}_{i} ( {x}_{n} ; {θ}_{i} ) ) + λ {‖ {w}_{i} ‖}_{1} \qquad Equation ( 2 )$$

This is a binary classification problem using the 0/1 loss and a penalty λ∥wᵢ∥₁, with a linear classifier ƒᵢ with parameters θᵢ={wᵢ, bᵢ}, over the set of “care” instances of node i using the pseudo labels determined earlier. The solution of this problem is as follows:
For axis-aligned trees, this can be solved exactly by enumeration, namely, trying each possible combination of (feature, threshold) and picking the one with lowest value of Eᵢ(θᵢ). This is the same procedure used by CART-type algorithms to optimize the impurity over a node in axis-aligned trees. For axis-aligned trees, the penalty λ∥wᵢ∥₁ may be removed from the equation because the weight vector wᵢ has all elements equal to zero except for one element which is equal to one, and thus, adds a constant to the equation.
For oblique trees, the above problem is NP-hard. It can be solved approximately by replacing the 0/1 loss in Equation (2) with a suitable surrogate loss. Examples of the latter include the logistic loss or the hinge loss (so the classifier is an L1-regularized logistic regression or L1-regularized linear support vector machine, respectively), for which a number of efficient algorithms exist (e.g., as implemented in the LIBLINEAR library).

Computing power increases, quantum computing, and similar improvements to computing power will likely change the complexity a NP-hard problem must have in order to merit an approximation rather than an exact solution.

### Pseudocode for the Preferred Embodiment of the TAO Algorithm

The following is pseudocode for a preferred embodiment of the tree alternating optimization (TAO) algorithm, in which the initial tree T is a complete binary tree of a user-set depth with random parameter values at the nodes. Visiting each node in reverse breadth-first search (BFS) order means scanning depths from depth (T) down to 0, and at each depth processing (in parallel, if so desired) all nodes at that depth. “Stop” occurs when either the parameters do not change any more (or change less than a set limit), or the number of iterations reaches a user-set limit.

| input | | training set {(xₙ, yₙ)}ₙ₌₁^{N} ⊂R^{D} × {1, . . . , K} |
|---|---|---|
| | | initial tree T |
| repeat | | |
| | for | d = depth (T) down to 0 |

for i ∈ nodes of T at depth d

if i is a leaf then

θᵢ ← majority label of the training instances that
reach i

else

θᵢ ← minimizer of the reduced problem, Eq. (2)

until stop
post process T: remove dead branches & pure subtrees
return T

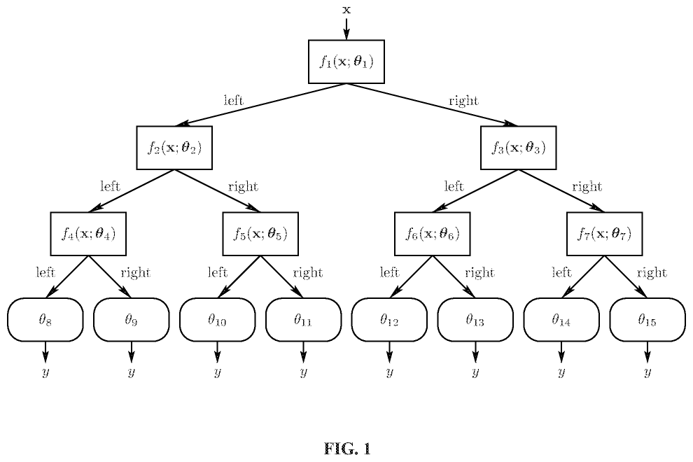

The behavior of TAO is illustrated in FIGS. 1-3. FIG. 1 shows a complete binary tree T (⋅; Θ) of depth 3, and the model at each node (decision function ƒᵢ(x; θᵢ) at each decision node, label θᵢ at each leaf). A given input x follows a path from the root to a single leaf which produces the output y=T (x; Θ). Assuming the values of the parameters are set randomly, this gives a possible initial tree on which to run TAO. Of course, one can use many other initial tree structures, including trees of a different depth and not necessarily complete (i.e., where each level of the tree is not full and leaves can appear at any level of the tree).

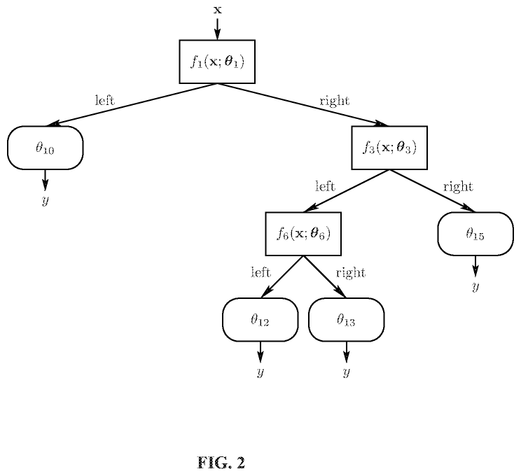

FIG. 2 shows the final tree structure after running TAO and post processing the tree. In this example, several branches received no training instances (namely the left branch of nodes 2 and 7 and the right branch of node 5; compare FIG. 1) and were removed (“dead branches”), so the tree was pruned. Of course, many other examples of a final tree structure for a tree learned by the TAO algorithm are possible, and the foregoing is just one example of a final tree structure from an initial tree of the structure of FIG. 1.

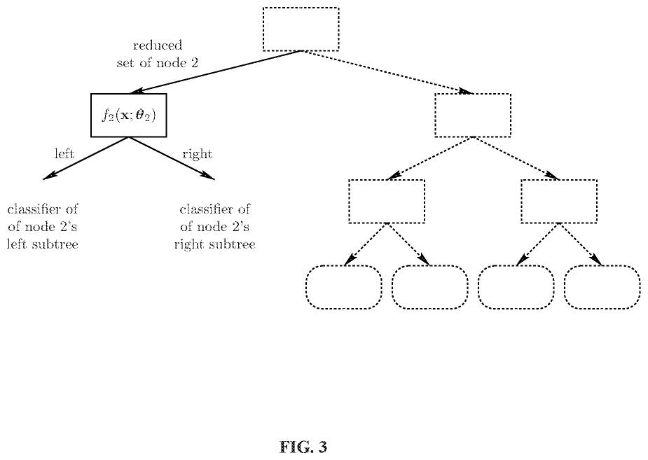

FIG. 3 illustrates schematically the optimization over node 2 in the tree of FIG. 1. The left and right subtrees of node 2 behave like two fixed classifiers which produce a label for an input x when going left or right in node 2, respectively. Only the training instances that reach node 2 under the current tree (the “reduced set” of node 2) participate in the optimization (in fact, only a subset of those, the “care set”, actually participates).

The node optimization described earlier is exact for a leaf, and for a decision node of an axis-aligned tree, but not for a decision node of an oblique tree, which is approximately solved via a surrogate classification loss. This can make the overall objective function of Equation (1) to increase slightly on occasion (usually in late-stage iterations, when TAO is close to converging). In a preferred embodiment, the node's parameters are updated whether they decrease the objective function or not, and TAO may be stopped when either the parameters do not change any more or the number of iterations reaches a user-set limit. It is also possible to update the node's parameters only if they reduce the objective function (and leave them unchanged otherwise). In this case, TAO may be stopped when either the decrease in the objective function is less than a user-set tolerance value or the number of iterations reaches a user-set limit.

### Sparse Oblique Trees

Sparse oblique trees are a new type of oblique trees, introduced here with the TAO algorithm, where each decision node uses only a (typically small) subset of features, rather than all features as in traditional oblique trees. Sparse oblique trees are obtained by using the A term (L1 penalty) in Equations (1) and (2).

Selecting appropriate values of A depends on the application and is up to the user. When λ equals zero, there is no sparsity penalty, and generally, all weight values will be nonzero and the classification accuracy will be high. In contrast, larger values of λ result in fewer nonzero elements in the weight vectors wᵢ of the nodes and a smaller tree, hence a more interpretable tree. If λ is too large, however, the tree will underfit, i.e., it will have a lower classification accuracy in test data. In an extreme case, with a very large value of λ, the tree will have only a single root node having all weights equal to zero (completely sparse). However, this is a useless model. Typically, trees that generalize well to test data can be obtained for an intermediate value of λ, striking a balance between classification accuracy and sparsity. These values depend on the training set and size of the tree. In some applications, it may be preferable to use a larger A value that underfits but gives a more interpretable tree.

A preferred and practical strategy to explore the values of λ is to learn a tree with TAO for a small user chosen value of λ and then learn trees for a set of increasing A values, where the increase in the value of λ and the number of A values in the set are also user chosen. Each new tree may be initialized from the previous tree (“warm-start”). The user can then choose the best tree by examining the training and test accuracy, and the sparsity, of the resulting trees.

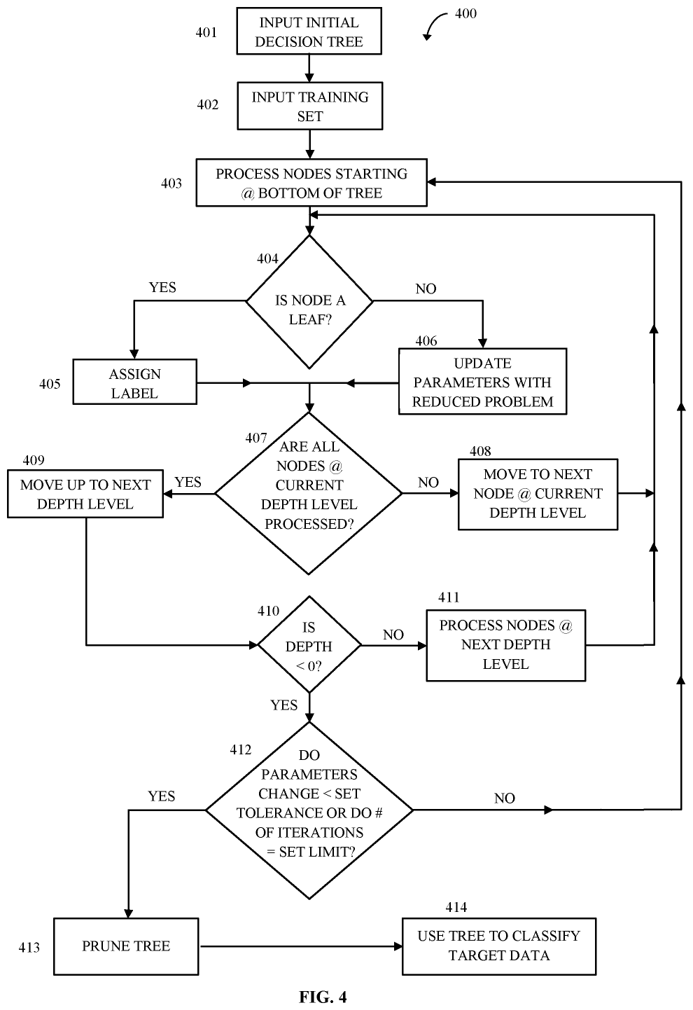

Referring now to FIG. 4, a computerized-implemented method 400 for learning a decision tree to optimize classification accuracy according to an embodiment is shown. The method starts at step 401 with input of an initial decision tree (e.g., the decision tree of FIG. 1). The initial tree input at step 401 may be a classification tree with a binary split at the nodes (either axis-aligned or oblique). At step 402, a training set of data is input, consisting of input instances and their respective label for learning/training the tree.

At step 403 the method 400 processes a first node at the bottom of the tree (at d=the maximum depth of the tree). In other words, in the preferred embodiment, the method processes the tree in reverse breadth first search order (i.e., from the leaves to the root). The steps 404 to 408 indicate a loop of the method 400 where the nodes at the same depth level of the tree (e.g., at a depth of d=5, 4, 3, 2, etc.) are processed. For example, for the tree of FIG. 1, we would first process nodes 8 to 15 (the leaves, at depth 3); then, nodes 4 to 7 (at depth 2); then, nodes 2 to 3 (at depth 1); and finally, node 1 (at depth 0).

At step 404 it is determined whether the node is a leaf. If the node is a leaf, then at 405, the leaf is assigned a label that is the majority label of training points that reach the leaf (the “reduced set” of training points). If the node is not a leaf, but instead is a decision node, at step 406, the parameters of the node's decision function are updated based on the solution to the reduced problem of Equation 2.

At 407, it is determined whether all nodes at the current depth level have been processed. If the answer is no, then at step 408 the method proceeds to the next node at the current depth level, until all nodes at that depth level have been processed. In some embodiments all nodes at the same depth level are processed/optimized in parallel, and thus, all nodes at the depth would be processed contemporaneously or nearly contemporaneously.

If the answer at step 407 is “yes,” then at step 409, the method moves up to the next depth level (i.e., the current depth level −1). At step 410, the method determines whether this next depth level is “<0.” In other words, has the entire tree from leaves to root been processed. If the answer is “no,” then at step 411 the method moves to process the nodes at that next depth level, and the loop of steps 404-408 are repeated. If the nodes at this next depth level are being processed in parallel, then all nodes at that level will be processed contemporaneously or nearly contemporaneously. After all nodes at the next level are processed and the answer at step 407 is “yes,” then at step 409, the method again moves up to the next depth level. In other words, the steps 404 through 411 are repeated until the answer at step 410 is “yes” (i.e., all nodes in the entire tree have been processed).

If all of the nodes in the tree have been processed, then at step 412, the method 400 determines whether the change in the parameters of the nodes are less than a set tolerance, or the number of iterations equals a set limit. If “no,” then the method 400 iterates beginning again at step 403, by moving to a node at a depth d equal to the depth of the tree. In other words, in the preferred embodiment, each iteration of the method 400 begins at the bottom of the tree and processes nodes in reverse breadth first search order.

If the change in the parameters is less than a set tolerance, or the number of iterations has reached a set (whether fixed, dynamically set, set in light of computing resources, or otherwise) limit, then at step 413, the tree is pruned to remove dead branches and pure subtrees. This gives the final tree, which, in typical embodiments having a large enough user selected A value in the reduced problem, may be a sparse oblique tree. Subsequently, at step 414, the tree is used to classify target data in a client system as needed.

As noted, in preferred embodiments, in the loop starting at 403, the TAO algorithm visits the tree nodes in reverse BFS order. However, other orders are possible. The only condition required is that, for each set of nodes that are optimized jointly, the nodes in the set may not be descendants of each other (e.g., nodes at the same depth level).

In preferred embodiments, when optimizing jointly over a set of nodes, such nodes may be processed in parallel, which greatly reduces, the time of learning a tree.

In embodiments in which the nodes of the tree are axis-aligned, the reduced problem (Equation 2) may be performed without utilization of a penalty (i.e., without the factor λ∥wᵢ∥₁, since it becomes constant, independent of the node parameters). In decision trees having oblique nodes, the penalty factor is used.

In some embodiments, the decision tree may be pruned to remove dead branch and pure subtrees after each iteration of TAO instead of waiting until iterations are complete.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. A distributed computing system may also be utilized.

In one or more exemplary designs, the functions described may be implemented in hardware, software, firmware, or any combination thereof. If implemented in software, the functions may be stored on or transmitted over as one or more instructions or code on a non-transitory computer-readable medium. Computer-readable media may include both computer storage media and nontransitory communication media including any medium that facilitates transfer of a computer program from one place to another. A storage media may be any available media that can be accessed by a general purpose or special purpose computer. By way of example, and not limitation, such non-transitory computer readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general purpose or special-purpose computer, or a general-purpose or special-purpose processor.

The previous description of the disclosed embodiments is provided to enable any person skilled in the art to make or use the embodiments disclosed. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A computer-implemented method for learning a decision tree to optimize classification accuracy, the method comprising:
inputting an initial decision tree having a binary split at each node;
inputting an initial data training set;
for each node i of the decision tree:
if the node is a leaf, assigning a label to the leaf based at least in part on a majority label of training points that reach the leaf; and
if the node is a decision node, updating parameters of the node's decision function based on solution of a reduced problem:
$${E}_{i} ( {θ}_{i} ) = {\sum }_{n ∈ care set} L ( {\overline{y}}_{n} , {f}_{i} ( {x}_{n} ; {θ}_{i} ) )$$
where ƒᵢ (⋅; θᵢ) is the decision function of the node i, γ̅ₙϵ{left, right} is a child that leads to the correct classification for xₙ under i's current subtree, and L is the 0/1 loss;
iterating over all nodes of the decision tree until the parameters change less than a set tolerance or a number of iterations reaches a set limit;
where, for each iteration, a set of nodes at the same depth level are processed;
pruning a resulting tree to remove dead branches and pure subtrees; and
using the resulting tree on a client system to classify input from target data.

2. The computer-implemented method of claim 1, where pruning the resulting tree occurs only after a last iteration when the parameters change less than a set tolerance or a number of iterations reaches a set limit.

3. The computer-implemented method of claim 1, where each iteration is performed in reverse breadth-first search (BFS) order.

4. The computer-implemented method of claim 1, where the set of nodes at the same depth level are processed in parallel.

5. The computer-implemented method of claim 1, where the initial decision tree is an oblique tree and a penalty λ∥wᵢ∥₁ is added to the reduced problem for every decision node processed in the tree.

6. The computer-implemented method of claim 1, where the parameters of the node's decision function are updated only if the objective function decreases.

7. The computer-implemented method of claim 1, where the initial decision tree is an axis-aligned tree.

8. The computer-implemented method of claim 1, where iterating over all nodes of the tree continues until the parameters change less than a set tolerance.

9. The computer-implemented method of claim 1, where iterating over all nodes of the tree continues until a number of iterations reaches a set limit.

10. The computer-implemented method of claim 1, where the initial decision tree is not complete.

11. The computer-implemented method of claim 1, where the initial decision tree has random parameter values in the nodes.

12. A computer-implemented method for learning a decision tree to optimize classification accuracy, the method comprising:
inputting an initial decision tree having a binary split at each node;
inputting an initial data training set;
for each node i of the tree:
if the node is a leaf, assigning a label to the leaf based at least in part on a majority label of training points that reach the leaf; and
if the node is a decision node, updating parameters of the node's decision function based on solution of a reduced problem:
$${E}_{i} ( {θ}_{i} ) = {\sum }_{n ∈ care set} L ( {\overline{y}}_{n} , {f}_{i} ( {x}_{n} ; {θ}_{i} ) ) + λ {‖ {w}_{i} ‖}_{1}$$
where ƒᵢ(⋅; θᵢ) is the decision function of the node i, γ̅ₙϵ{left, right} is a child that leads to the correct classification for xₙ under i's current subtree, L is the 0/1 loss, and where wᵢ is a weight vector and λ is a user set hyperparameter with a value ≥0;
iterating over all nodes of the tree until the parameters change less than a set tolerance or a number of iterations reaches a set limit;
where, for each iteration, all nodes at a same depth level are processed in parallel;
pruning a resulting tree to remove dead branches and pure subtrees; and
using the resulting tree on a client system to classify input from target data.

13. The computer-implemented method of claim 12, where pruning the resulting tree occurs only after a last iteration when the parameters change less than a set tolerance or a number of iterations reaches a set limit.

14. The computer-implemented method of claim 12, where the initial decision tree is an oblique tree.

15. The computer-implemented method of claim 12, where each iteration is performed in reverse breadth-first search (BFS) order.

16. The computer-implemented method of claim 12, where the initial decision tree has random parameter values in the nodes.

17. The computer implemented method of claim 12, where the parameters of the node's decision function are updated only if the objective function decreases.

18. A computer-implemented method for learning a sparse decision tree to optimize classification accuracy and sparsity, the method comprising:
inputting an initial binary decision tree having oblique nodes;
inputting an initial data training set;
for each node i of the tree:
if the node is a leaf, assigning a label to the leaf based at least in part on a majority label of training points that reach the leaf; and
if the node is a decision node, updating parameters of the node's decision function based on solution of a reduced problem:
$${E}_{i} ( {θ}_{i} ) = {\sum }_{n ∈ care set} L ( {\overline{y}}_{n} , {f}_{i} ( {x}_{n} ; {θ}_{i} ) ) + λ {‖ {w}_{i} ‖}_{1}$$
where ƒᵢ (⋅; θᵢ) is the decision function of the node, y̅ₙϵ{left, right} is a child that leads to the correct classification for xₙ under i's current subtree, L is the 0/1 loss, and where wᵢ is a weight vector and λ is a user set hyperparameter with a value ≥0, set at an initial value;
iterating over all nodes of the tree until the parameters change less than a set tolerance or a number of iterations reaches a set limit;
where, for each iteration, all nodes at the same depth level are processed in parallel;
pruning a resulting tree to remove dead branches and pure subtrees;
repeating the above steps of the computer-implemented method, where the initial binary decision tree input is a previous tree and each repeat has a user-chosen value of λ larger than a previous λ value to produce new resulting trees;
choosing a best tree from the new resulting trees based on the accuracy and sparsity of each of the new resulting trees; and
using the best tree on a client system to make predictions from target data.

19. The computer-implemented method of claim 18, where each iteration is performed in reverse breadth-first search (BFS) order.

20. The computer-implemented method of claim 18, where the initial decision tree has random parameter values in the nodes.
